(19) United States
(12) Patent Application Publication
(10) Pub. No.: US 2021/0271981 A1
(43) Pub. Date: Sep. 2, 2021

(54) ELECTRONIC APPARATUS AND METHOD FOR CONTROLLING THEREOF

(71) Applicant: Samsung Electronics Co., Ltd., Gyeonggi-do (KR)

(72) Inventors: Dongsoo LEE, Gyeonggi-do (KR); Baeseong PARK, Gyeonggi-do (KR); Byeoungwook KIM, Gyeonggi-do (KR); Sejung KWON, Gyeonggi-do (KR); Yongkweon JEON, Gyeonggi-do (KR)

(73) Assignee: Samsung Electronics Co., Ltd.

(21) Appl. No.: 17/171,582

(22) Filed: Feb. 9, 2021

(30) Foreign Application Priority Data
Mar. 2, 2020 (KR) 10-2020-0026010

(51) Int. Cl. G06N 3/10; G06F 17/16; G06N 3/08

(52) U.S. Cl. CPC G06N 3/10; G06N 3/08; G06F 17/16

(57) ABSTRACT

An electronic apparatus performing an operation of a neural network model is provided. The electronic apparatus includes a memory configured to store weight data including quantized weight values of the neural network model; and a processor configured to obtain operation data based on input data and binary data having at least one bit value different from each other, generate a lookup table by matching the operation data with the binary data, identify operation data corresponding to the weight data from the lookup table, and perform an operation of the neural network model based on the identified operation data.

### CROSS-REFERENCE TO RELATED APPLICATION(S)

This application is based on and claims priority under 35 U.S.C. § 119(a) to Korean Patent Application No. 10-2020-0026010, which was filed in the Korean Intellectual Property Office on Mar. 2, 2020, the entire disclosure of which is incorporated herein by reference.

### BACKGROUND

### 1. Field

The disclosure relates generally to an electronic apparatus and a method for controlling the electronic apparatus, and more particularly, to an electronic apparatus that operates based on artificial intelligence (AI) technology, and a method for controlling the electronic apparatus.

### 2. Description of Related Art

AI systems implementing intelligence of a human level are being developed. An AI system may include a system in which a machine learns and determines by itself, unlike conventional rule-based smart systems. AI systems are being utilized in various areas, such as voice recognition, image recognition, and future prediction.

More recently, AI systems for resolving a given problem through a deep neural network based on deep learning are being developed.

A deep neural network includes a plurality of hidden layers between an input layer and an output layer, and provides a model implementing an AI technology through neurons included in each layer. A deep neural network as described above generally includes a plurality of neurons for deriving an accurate result value. However, when such a large number of neurons exist, although the accuracy of an output value for an input value may increase, there is a problem that a lot of time must be spent to derive an output value. Also, there is a problem that, due to the large number of neurons, a deep neural network cannot be used in mobile devices, such as a smartphone having a limited memory, due to the problem of capacity, etc.

### SUMMARY

The disclosure is provided to address at least the aforementioned problems, and to provide at least the advantages described below.

An aspect of the disclosure is to provide an electronic apparatus that accurately derives an output value within a short time, and allows implementation of an AI technology in mobile devices having a limited hardware and memory resources.

In accordance with an aspect of the disclosure, an electronic apparatus is provided for performing an operation of a neural network model. The electronic apparatus includes a memory configured to store weight data including quantized weight values of the neural network model; and a processor configured to obtain operation data based on input data and binary data having at least one bit value different from each other, generate a lookup table by matching the operation data with the binary data, identify operation data corresponding to the weight data from the lookup table, and perform an operation of the neural network model based on the identified operation data.

In accordance with an aspect of the disclosure, a method is provided for controlling an electronic apparatus to perform an operation of a neural network model. The method includes obtaining operation data based on input data and binary data including at least one bit value different from each other; generating a lookup table by matching the operation data with the binary data; identify operation data corresponding to weight data including quantized weight values of the neural network model from the lookup table; and performing an operation of the neural network model based on the identified operation data.

### BRIEF DESCRIPTION OF THE DRAWINGS

The above and other aspects, features, and advantages of certain embodiments of the disclosure will be more apparent from the following detailed description taken in conjunction with the accompanying drawings, in which:

FIG. 1 illustrates an electronic apparatus according to an embodiment;

FIG. 2A illustrates a matrix corresponding to input data according to an embodiment;

FIG. 2B illustrates a lookup table according to an embodiment;

FIG. 3A illustrates an operation of a neural network model using a lookup table according to an embodiment;

FIG. 3B illustrates lookup tables used for each column of a matrix corresponding to output data according to an embodiment;

FIG. 3C illustrates an operation of obtaining an output value of a first column of a matrix corresponding to output data according to an embodiment;

FIG. 3D illustrates an operation of obtaining an output value of a second column of a matrix corresponding to output data according to an embodiment;

FIG. 3E illustrates an operation of obtaining an output value of a third column of a matrix corresponding to output data according to an embodiment;

FIG. 3F illustrates a matrix for deriving output data from input data according to an embodiment;

FIG. 4A illustrates an operation expression used in generation of a lookup table according to an embodiment;

FIG. 4B illustrates an intermediate operation expression included in a plurality of operation expressions according to an embodiment;

FIG. 4C illustrates an intermediate operation expression included in a plurality of operation expressions according to an embodiment;

FIG. 4D illustrates an intermediate operation expression included in a plurality of operation expressions according to an embodiment;

FIG. 4E illustrates an intermediate operation expression included in a plurality of operation expressions according to an embodiment;

FIG. 4F illustrates an operation of obtaining an operation value based on an intermediate operation expression according to an embodiment;

FIG. 5 illustrates an operation method of a neural network model according to an embodiment;

FIG. 6 illustrates an electronic apparatus according to an embodiment; and

FIG. 7 is a flow chart illustrating a control method of an electronic apparatus according to an embodiment.

### DETAILED DESCRIPTION

Hereinafter, various embodiments of the disclosure will be described with reference to the accompanying drawings. However, the various embodiments do not limit the technology described in the disclosure to a specific embodiment, but should be interpreted to include various modifications, equivalents and/or alternatives of the embodiments of the disclosure. With respect to the detailed description of the drawings, similar components may be designated by similar reference numerals.

Expressions such as “have,” “may have,” “include” and “may include” should be construed as denoting that there are such characteristics (e.g. elements such as numerical values, functions, operations, and components), and the expressions are not intended to exclude the existence of additional characteristics.

The expressions “A or B,” “at least one of A and/or B,” or “one or more of A and/or B”, etc., may include all possible combinations of the listed items. For example, “A or B,” “at least one of A and B,” or “at least one of A or B” may refer to all of the following cases: (1) including at least one A, (2) including at least one B, or (3) including at least one A and at least one B.

Further, the expressions “first,” “second,” etc., may be used to describe various elements regardless of any order and/or degree of importance. Such expressions are used only to distinguish one element from another element, and are not intended to limit the elements.

A description that one element (e.g. a first element) is “(operatively or communicatively) coupled with/to” or “connected to” another element (e.g. a second element) should be interpreted to include both the case where the one element is directly coupled to the another element, and the case where the one element is coupled to the another element through still another element (e.g. a third element). In contrast, a description that one element (e.g. a first element) is “directly coupled” or “directly connected” to another element (e.g. a second element) can be interpreted to mean that still another element (e.g. a third element) does not exist between the one element and the another element.

The expression “configured to” may be interchangeably used with other expressions such as “suitable for,” “having the capacity to,” “designed to,” “adapted to,” “made to,” and “capable of,” depending on cases. The term “configured to” does not necessarily mean that a device is “specifically designed to” in terms of hardware. Instead, under some circumstances, the expression “a device configured to” may mean that the device “is capable of” performing an operation together with another device or component. For example, the phrase “a processor configured to perform A, B, and C” may mean a dedicated processor (e.g. an embedded processor) for performing the corresponding operations, or a generic-purpose processor (e.g. a central processing unit (CPU) or an application processor (AP)) that can perform the corresponding operations by executing one or more software programs stored in a memory device.

In addition, “a module” or “a part” performs at least one function or operation, and may be implemented as hardware or software, or as a combination of hardware and software. Further, a plurality of “modules” or “parts” may be integrated into at least one module and implemented as at least one processor, except “modules” or “parts” that are described as being necessarily implemented as specific hardware.

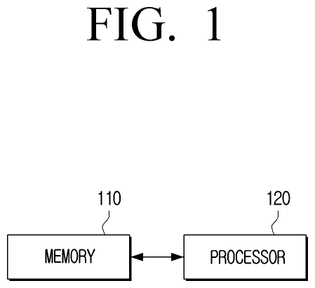

FIG. 1 illustrates an electronic apparatus according to an embodiment.

Referring to FIG. 1, the electronic apparatus includes a memory 110 and a processor 120.

The electronic apparatus derives output data from input data by using a neural network model (or an AI model), and the electronic apparatus may include a desktop personal computer (PC), a laptop computer, a smartphone, a tablet PC, a server, etc. Alternatively, the electronic apparatus may be a system wherein a clouding computing environment is constructed. However, the disclosure is not limited thereto, and the electronic apparatus may be any suitable apparatus capable of performing an operation of a neural network model.

The memory 110 may include a hard disk, a non-volatile memory, a volatile memory, etc. A non-volatile memory may be a one-time programmable read only memory (OTPROM), a programmable ROM (PROM), an erasable and programmable ROM (EPROM), an electrically erasable and programmable ROM (EEPROM), a mask ROM, a flash ROM, etc., and a volatile memory may be a dynamic RAM (DRAM), a static RAM (SRAM), a synchronous dynamic RAM (SDRAM), etc.

Meanwhile, in FIG. 1, the memory 110 is illustrated as a separate component from the processor 120, but the memory 110 may be included in the processor 120. That is, the memory 110 may not only be implemented as an off-chip memory, but also be implemented as an on-chip memory.

Although FIG. 1 illustrates one memory 110, the memory 110 may be implemented as a plurality of memory elements.

The memory 110 may store weight data of a neural network model. The weight data may be a used for an operation of a neural network model, and the memory 110 may store a plurality of weight data corresponding to a plurality of layers constituting a neural network model.

The memory 110 may store weight data including quantized weight values. A quantized weight value may be −1 or 1, and weight data may be expressed as a matrix of m×n consisting of −1 or 1. Alternatively, the weight value −1 may be replaced with 0 and stored in the memory 110. That is, the memory 110 may store weight data consisting of 0 or 1. Weight data including weight values of −1 or 1 may be stored in a first memory (e.g., a hard disk), and weight data including weight values of 0 or 1 may be stored in a second memory (e.g., an SDRAM).

Quantization of a neural network model may be performed by the processor 120 of the electronic apparatus 100, and also be performed by an external apparatus (e.g., a server). When quantization of a neural network model is performed by an external apparatus, the processor 120 may receive weight data including quantized weight values from the external apparatus, and store the weight data in the memory 110.

A neural network model as described above may be based on a neural network. For example, a neural network model may be based on a recurrent neural network (RNN), i.e., a kind of deep learning model for learning data that changes according to passage of time such as time series data. However, the disclosure is not limited thereto, and a neural network model may be based on various networks, such as a convolutional neural network (CNN), a deep neural network (DNN), a restricted Boltzmann machine (RBM), a deep belief network (DBN), a bidirectional recurrent deep neural network (BRDNN), etc.

Alternatively, the memory 110 may store a model generated based on rules, but not a model trained through an AI algorithm. Essentially, there is no special limitation on a model stored in the memory 110.

The processor 120 controls the overall operations of the electronic apparatus. Accordingly, the processor 120 may include one processor or a plurality of processors. The one processor or the plurality of processors may be generic-purpose processors such as a CPU, and may also be graphic-dedicated processors, such as a graphic processing unit (GPU), or AI-dedicated processors, such as a neural network processing unit (NPU). The processor 120 may be a System on Chip (SoC) (e.g., an on-device AI chip), large scale integration (LSI), or a field programmable gate array (FPGA).

The processor 120 may quantize weight values of a neural network model. Specifically, when quantizing weight values with a k^{th} bit, the processor 120 may quantize weight values of a neural network model through various quantization algorithms satisfying Equation (1).

$${min}_{\{ {α}_{i} , {b}_{i} \} {k}_{i = 1}} {‖ w - {\sum }_{i = 1}^{k} {α}_{i} {b}_{i} ‖}^{2} \qquad ( 1 )$$

In Equation (1), w is a weight value before quantization and α is a scaling factor. Additionally, b is a quantized weight value, which may be −1 or +1.

The processor 120 may quantize a weight value through a greedy algorithm. The processor 120 may obtain a scaling factor and a quantized weight value for k=1 in Equation (1) based on Equation (2).

$${b}^{⋆} = sign ( w ) , {α}^{⋆} = \frac{{w}^{T} {b}^{⋆}}{n} \qquad ( 2 )$$

In Equation (2), w is a weight value before quantization and α* is a scaling factor when k=1. Additionally, b* is a quantized weight value when k=1, and it may be −1 or +1. Further, n may be an integer greater than or equal to 1.

The processor 120 may obtain a scaling factor and a quantized weight value when k=i (1<i≤k) by repetitively utilizing Equation (3). That is, the processor 120 may obtain a scaling factor and a quantized weight value when k=i (1<i≤k) by using r, which is a difference between a weight value before quantization and a quantized weight value when k=1.

$${min}_{{α}_{i} , {b}_{i}} {‖ {r}_{i - 1} - {α}_{i} {b}_{i} ‖}^{2} , where {r}_{i - 1} = w - {\sum }_{j = 1}^{i - 1} {α}_{j} {b}_{j} , 1 < i \leq k \qquad ( 3 )$$

In Equation (3), w is a weight value before quantization and α is a scaling factor. Additionally, b is a quantized weight value, which may be −1 or +1. Further, r represents a difference between a weight value before quantization and a quantized weight value when case k=1.

The electronic apparatus may store weight data including a scaling factor, and weight values quantized to −1 or 1 in the memory 110. Although FIG. 1 is described above using a greedy algorithm, there is no special limitation on a method for quantizing a weight value. For example, quantization may be performed through various different algorithms, such as unitary quantization, adaptive quantization, uniform quantization, supervised iterative quantization, etc.

The processor 120 may derive output data from the input data based on quantized weight values of a neural network model. The input data may be text, an image, a user voice, etc. For example, the text may be text input through an input such as a keyboard or a touch pad, and the image may be an image photographed through a camera of the electronic apparatus. The user voice may be spoken into a microphone of the electronic apparatus.

The output data may be different according to the kind of input data and/or the neural network model. That is, the output data may differ according to what kind of input data is input into what kind of neural network model. For example, when the neural network model is for language translation, the processor 120 may derive output data expressed in a second language from input data expressed in a first language. When the neural network model is for image analysis, the processor 120 may receive an image as input data of the neural network model, and derive information on an object detected from the image as output data. When the neural network model is for voice recognition, the processor 120 may receive a user voice as input data, and derive text corresponding to the user voice as output data. The aforementioned examples of output data are not limiting, and the kinds of output data may vary.

When input data is received, the processor 120 may express the input data as a matrix (or a vector or a tensor) including a plurality of input values. The method for expressing the input data as a matrix (or a vector or a tensor) may vary according to the kind and the type of the input data. For example, when text (or text that is converted from a user voice) is input data, the processor 120 may express the text as a vector through one-hot encoding or word embedding. One-hot encoding is a method of expressing only the value of the index of a specific word as 1 and expressing the values of the remaining indices as 0, and word embedding is a method of expressing a word as a real number with a dimension of a vector set by a user (e.g., 128 dimensions). As a method for word embedding, Word2Vec, FastText, Glove, etc., may be used. When an image is the input data, the processor 120 may express each pixel of the image as a matrix. For example, the processor 120 may express each pixel of the image as values of 0 to 255 for each of red, green, blue (RGB) colors, or express the image as a matrix with a value of dividing values expressed as 0 to 255 by a predetermined value (e.g., 255).

The processor 120 may derive at least one intermediate data from the input data based on quantized weight values and an input value of the input data, and then derive output data for the at least one intermediate data.

Unlike a conventional electronic apparatus deriving output data from input data by performing a matmul operation for a plurality of quantized weight values and a plurality of input values, the processor 120 may derive output data from input data by using a lookup table. This prevents a problem of latency that occurs conventionally when a plurality of matmul operations are performed and prevents a phenomenon of memory overload.

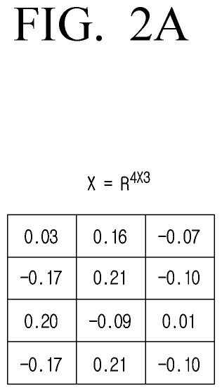

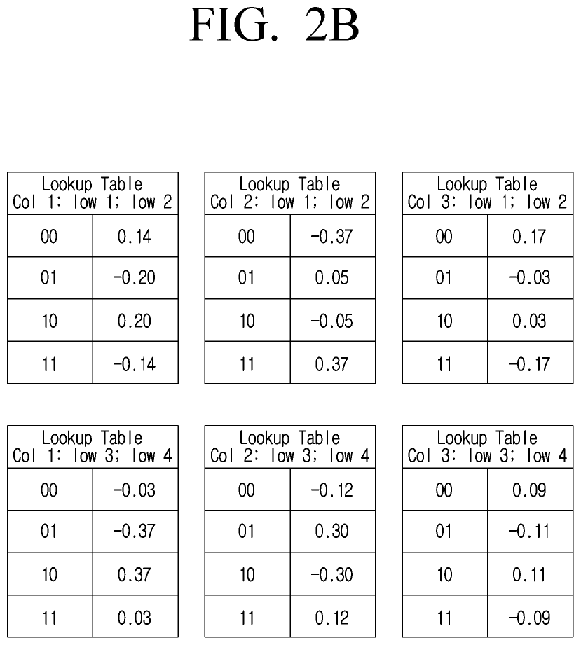

FIG. 2A illustrates a matrix corresponding to input data according to an embodiment, and FIG. 2B illustrates a lookup table according to an embodiment.

As described above with reference to FIG. 1, the processor 120 may obtain input data in the form of a matrix (or a vector or a tensor) including a plurality of input values. For example, the processor 120 may obtain a 4×3 matrix including a plurality of input values as illustrated in FIG. 2A.

The processor 120 may generate a lookup table based on input values of input data and binary data. The binary data may include n bit values having a value of 0 or 1. The amount of binary data may be 2ⁿ. For example, binary data of 2 bits may include two bit values, each having a value of 0 or 1, and may be 00, 01, 10, or 11. As another example, binary data of 4 bits may include four bit values, such as 0000, 0001, 0010, 0011, 0100, 0101, 0110, 0111, 1000, 1001, 1010, 1011, 1100, 1101, 1110, or 1111.

The processor 120 may obtain n input values from each column of an input matrix, and obtain operation data based on bit values of binary data and the obtained n input values. The bit values of the binary data may be 0 or 1 as described above, and the processor 120 may apply −1 to the input values when the bit values of the binary data are 0, and apply 1 to the input values when the bit values of the binary data are 1. Thereafter, the processor 120 may generate a lookup table by matching the obtained operation data with each of the binary data.

Referring to FIGS. 2A and 2B, when n=2, the processor 120 may obtain input values 0.03 and −0.17 of the first and second rows in the first column of the input matrix. The processor 120 may obtain an operation value 0.14 by operating −(0.03)−(−0.17), and match the operation value 0.14 with the binary data 00. Similarly, the processor 120 may obtain an operation value −0.20 by operating −(0.03)+(−0.17), match the operation value −0.20 to the binary data 01, and obtain an operation value 0.20 by operating (0.03)−(−0.17), and match the operation value 0.20 to the binary data 10. The processor 120 may obtain an operation value −0.14 by operating (0.03)+(−0.17), and match the operation value −0.14 to the binary data 11. The processor 120 may obtain the input values 0.20 and −0.17 of the third and fourth rows in the first column. The processor 120 may obtain an operation value −0.37 by operating −(0.20)−(0.17), and match the operation value −0.37 with the binary data 00. Similarly, the processor 120 may obtain an operation value −0.03 by operating −(0.20)+(0.17), and match the operation value −0.03 with the binary data 01. The processor 120 may obtain an operation value 0.03 by operating (0.20)−(0.17), and match the operation value 0.03 with the binary data 10, and obtain an operation value 0.37 by operating (0.20)+(0.17), and match the operation value 0.37 to the binary data 11. Similarly, the processor 120 may obtain operation values for the input values of the second column and the input values of the third column of the input matrix, and match the operation values with the binary data. The aforementioned case wherein n=2 is a non-limiting example, and n may be changed according to a user setting.

The processor 120 may generate at least one lookup table for each column of the input matrix. As described above, when the input matrix is a 4×3 matrix, and n=2, the processor 120 may generate two lookup tables for each column of the input matrix, i.e., six lookup tables in total as illustrated in FIG. 2B. When n=4, the processor 120 may generate one lookup table for each column of the input matrix, i.e., three lookup tables in total.

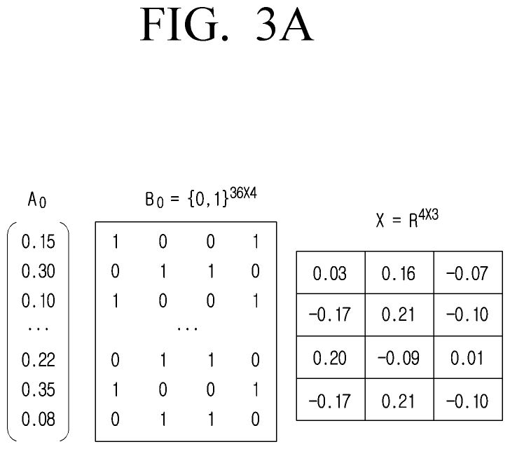

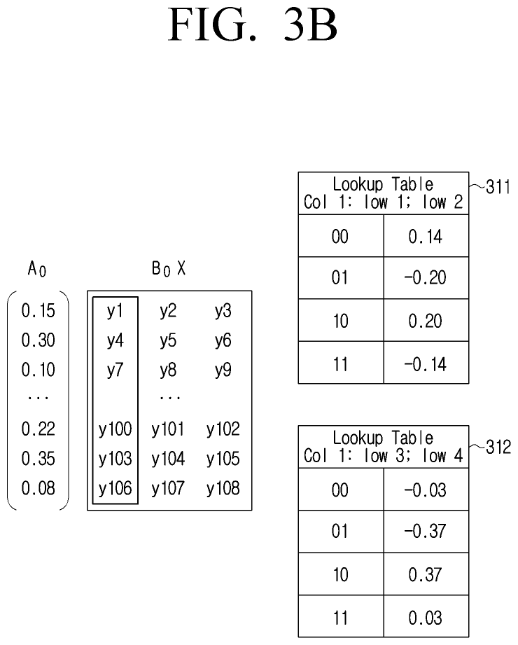

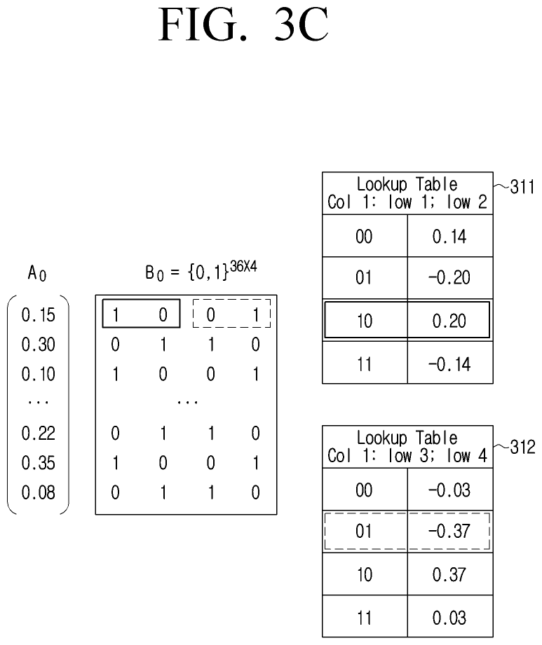

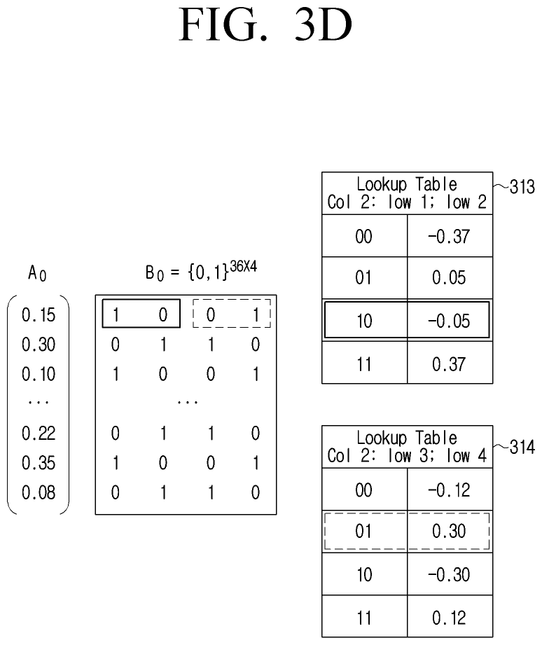

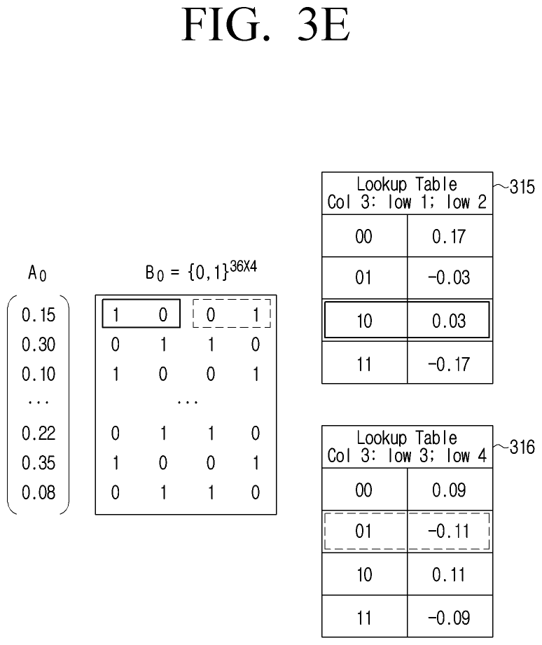

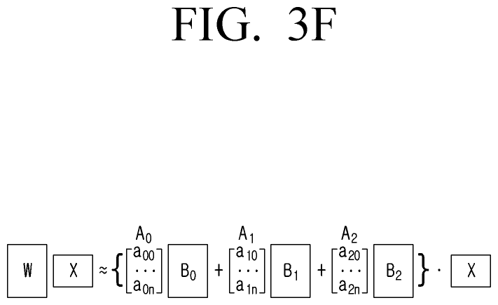

FIG. 3A illustrates an operation of a neural network model using a lookup table according to an embodiment.

As described above, the processor 120 may derive output data based on quantized weight values and input values of input data. Specifically, the processor 120 may derive output data for input data X based on an operation of weight data W (this may include a scaling factor A and a quantized weight value B) and the input data X. When weight values of the weight data are quantized to 3 bits, the processor 120 may derive output data from input data X based on Equation (4) below.

WX≈(AoBo+A₁B₁+A₂B₂)*X (4)

Equation (4) may be expressed in matrix form, as illustrated in FIG. 3F.

Referring to FIG. 3F, a scaling factor Ao, a quantized weight value Bo, and input data X (when k=1) may have values as illustrated in FIG. 3A. Unlike a conventional electronic apparatus obtaining an operation value of B*X through a matmul operation, an electronic apparatus according to an embodiment of the disclosure may obtain an operation value of B*X through references of a lookup table.

FIG. 3B illustrates lookup tables used for each column of a matrix corresponding to output data according to an embodiment.

Referring to FIG. 3B, an output matrix including operation values of Bo*X may have output values of from y1 to y108. The processor 120 may determine lookup tables corresponding to each column of the output matrix among a plurality of lookup tables generated for each column of the input matrix, for obtaining output values. Specifically, the processor 120 may determine lookup tables generated based on the input matrix of the same column as the column of the output matrix as lookup tables for obtaining output values of the output matrix. The processor 120 may determine the first lookup table 311 and the second lookup table 312 generated based on the input values of the first column of the input matrix among the plurality of lookup tables as lookup tables for obtaining output values of the first column of the output matrix.

The processor 120 may identify n weight values corresponding to n input values in each row of a weight matrix including weight values of 0 or 1. That is, when lookup tables are generated by obtaining n input values in each column of the input matrix, the processor 120 may identify n weight values corresponding to n input values in each row of the weight matrix. When n=2, the processor 120 may identify two weight values corresponding to two input values for each row in a matrix including weight values.

FIG. 3C illustrates an operation of obtaining an output value of a first column of a matrix corresponding to output data according to an embodiment.

Referring to FIG. 3C, the processor 120 may identify 1 and 0 and 0 and 1 in the first row of the weight matrix, identify 0 and 1 and 1 and 0 in the second row, and in a similar manner, identify two weight values in the remaining rows.

The processor 120 may identify binary data corresponding to the identified weight values among the binary data. The identified binary data includes the same bit values as the weight values. As illustrated in FIG. 3C, if the identified weight values are 1 and 0, the binary data corresponding to the weight values may be 10, and if the identified weight values are 0 and 1, the binary data corresponding to the weight values may be 01.

The processor 120 may obtain an operation value corresponding to binary data identified from a lookup table. More specifically, the processor 120 may determine a lookup table including operation values corresponding to the identified weight values among the plurality of lookup tables 311 and 312. Specifically, if the identified weight values are values included in the k column of the weight matrix, the processor 120 may determine a lookup table generated based on the input values of the k row of the input matrix, among the plurality of lookup tables, as a lookup table including operation values corresponding to the identified weight values. If the identified weight values are values included in the first and second columns of the weight matrix, the processor 120 may determine the first lookup table 311 generated based on the input values of the first and second rows of the input matrix, between the first and second lookup tables 311 and 312, as a lookup table including operation values corresponding to the identified weight values. If the identified weight values are values included in the third and fourth columns of the weight matrix, the processor 120 may determine the second lookup table 312 generated based on the input values of the third and fourth rows of the input matrix, between the first and second lookup tables 311 and 312, as a lookup table including operation values corresponding to the identified weight values.

The processor 120 may obtain an operation value 0.20 matched with the binary data 10 identified from the first lookup table 311, obtain an operation value −0.37 matched with the binary data 01 identified from the second lookup table 312, and obtain a y1 value of the output matrix through summing up the operation values 0.20 and 0.37. For the second row of the weight matrix, the processor 120 may obtain an operation value −0.20 matched with the binary data 01 identified from the first lookup table 311, obtain an operation value 0.37 matched with the binary data 10 identified from the second lookup table 312, and obtain a y4 value of the output matrix through summing up the operation values −0.20 and 0.37. For the nth row of the weight matrix, the processor 120 may obtain an output value through a similar manner.

FIG. 3D illustrates an operation of obtaining an output value of a second column of a matrix corresponding to output data according to an embodiment.

Referring to FIG. 3D, for the output values of the second column of the output matrix, the output values may be obtained from the third and fourth lookup tables 313 and 314.

FIG. 3E illustrates an operation of obtaining an output value of a third column of a matrix corresponding to output data according to an embodiment.

Referring to FIG. 3E, for the output values of the third column of the output matrix, the output values may be obtained from the fifth and sixth lookup tables 315 and 316. Here, the aforementioned technical idea can be applied, and thus, a repetitive detailed explanation will be omitted.

After the output values of the output matrix are obtained, the processor 120 may perform an operation of the output matrix and the scaling factor, and accordingly, obtain a result value of the aforementioned Equation (4). The processor 120 may output the final output data by using the obtained result value. As described above, if the neural network model is for language translation, the output data may be text in a different language from the text input data, and if the neural network model is for image analysis, the output data may be include information on objects included in an input image. However, the output data is not limited these examples.

As described above, output values are obtained through lookup tables without a matmul operation of quantized weight values and input values of input data, and thus, the problem of latency according to the large number of operations and a phenomenon of memory overload can be prevented.

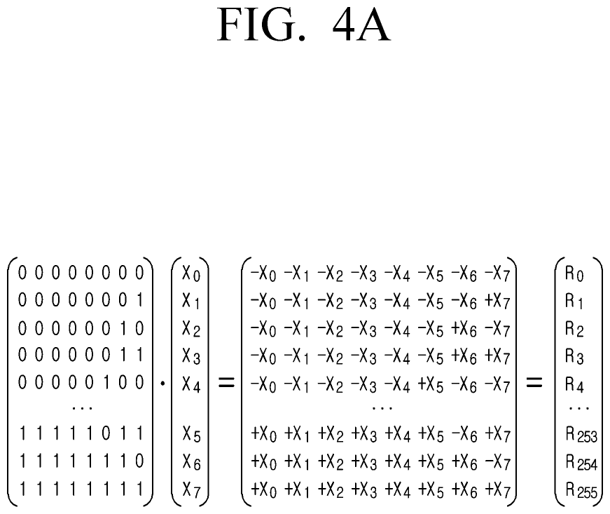

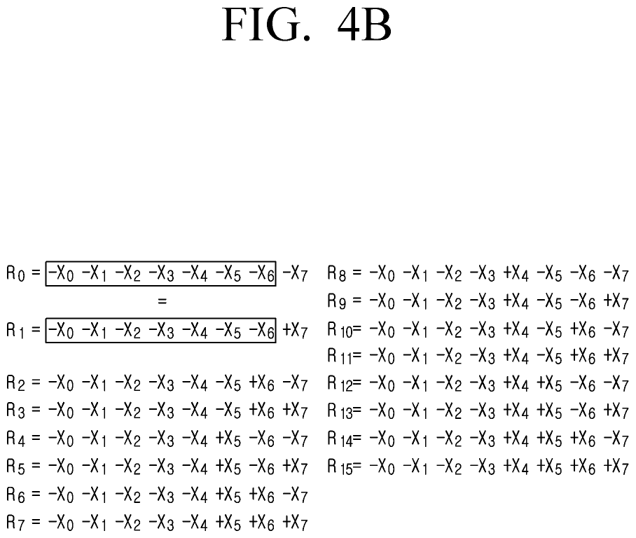

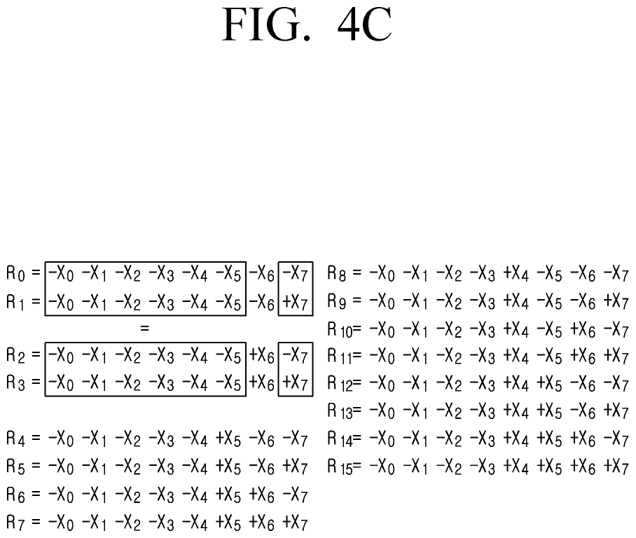

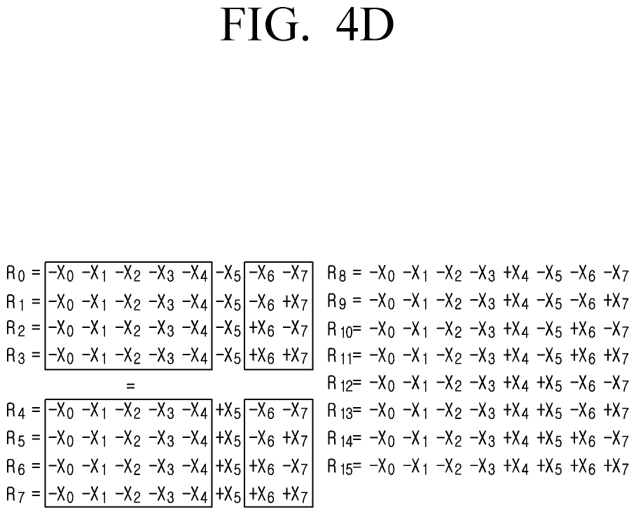

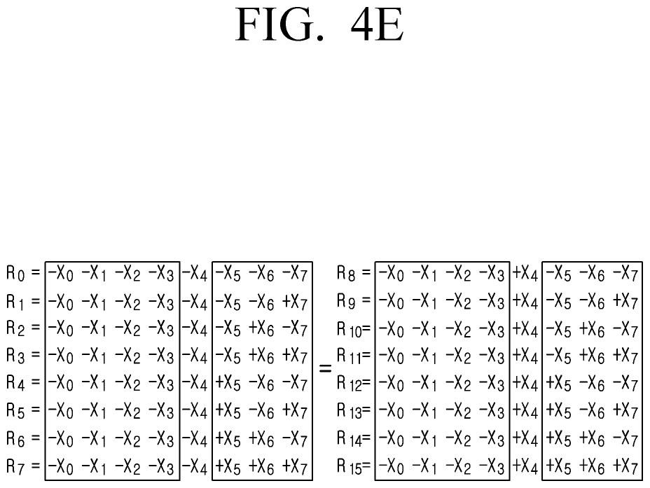

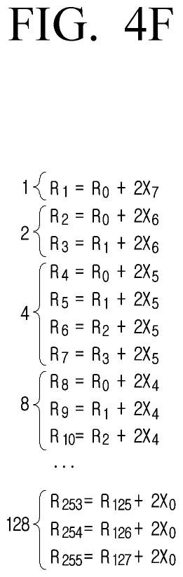

FIG. 4A illustrates an operation expression used in generation of a lookup table according to an embodiment.

Referring to FIG. 4A, the processor 120 may obtain operation values through a plurality of operation expressions based on binary data and n input values, and generate lookup tables by matching the operation values to each of the binary data. The plurality of operation expressions based on binary data and n input values may include the same intermediate operation expression. For example, when n=8, the plurality of operation expressions may be based on binary data of 8 bits and eight input values (x0 to x7). That is, when n=8, the operation expression for obtaining an operation value Ro corresponding to the binary data 00000000 is −x0−x1−x2−x3−x4−x5−x6−x7, and the operation expression for obtaining an operation value R1 corresponding to the binary data 00000001 is −x0−x1−x2−x3−x4−x5−x6+x7. Similarly, there may be a plurality of operation expressions for obtaining a plurality of operation values corresponding to each of R2 to R255. In this case, in obtaining operation values based on a plurality of operation expressions, the processor 120 may use the result value of the intermediate operation expression commonly included in the plurality of operation expressions.

FIG. 4B illustrates an intermediate operation expression included in a plurality of operation expressions according to an embodiment.

Referring to FIG. 4B, the operation expression −x0−x1−x2−x3−x4−x5−x6−x7 for obtaining Ro and the operation expression −x0−x1−x2−x3−x4−x5−x6−x7 for obtaining R1 include the same intermediate operation expression −x0−x1−x2−x3−x4−x5−x6.

FIG. 4C illustrates an intermediate operation expression included in a plurality of operation expressions according to an embodiment.

Referring to FIG. 4C, the operation expression −x0−x 1−x2−x3−x4−x5−x6−x7 for obtaining Ro and the operation expression −x0−x1−x2−x3−x4−x5+x6−x7 for obtaining R2 include the same intermediate operation expression −x0−x1−x2−x3−x4−x5−x7, and the operation expression −x0−x1−x2−x3−x4−x5−x6−x7 for obtaining R1 and the operation expression −x0−x1−x2−x3−x4−x5+x6+x7 for obtaining R3 may include the same intermediate operation expression x0−x1−x2−x3−x4−x5+x7.

FIG. 4D illustrates an intermediate operation expression included in a plurality of operation expressions according to an embodiment, and FIG. 4E illustrates an intermediate operation expression included in a plurality of operation expressions according to an embodiment.

Referring to FIGS. 4D and 4E, in a plurality of operation expressions for obtaining operation values, there may be a plurality of operation expressions including the same intermediate operation expression. More specifically, the processor 120 may perform an operation of any one operation expression among a plurality of operation expressions having the same intermediate operation expression based on an operation value of another operation expression. That is, as in the aforementioned embodiment, when the operation expression −x0−x1−x2−x3−x4−x5−x6−x7 for obtaining Ro and the operation expression −x0−x1−x2−x3−x4−x5−x6−x7 for obtaining R1 include the same intermediate operation expression −x0−x1−x2−x3−x4−x5−x6, the processor 120 may obtain Ro through the operation expression −x0−x1−x2−x3−x4−x5−x6−x7, and obtain R1 by adding 2*x7 to the operation value of R0 (i.e., R1=R0+2x7).

FIG. 4F illustrates an operation of obtaining an operation value based on an intermediate operation expression according to an embodiment.

Referring to FIG. 4F, the processor 120 may obtain the values of R2 to R255, and the processor 120 may obtain operation values through the illustrated plurality of operation expressions.

Although FIGS. 4A to 4F are described using n=8, the aforementioned technical idea can be applied to other values of n.

As described above, when including the same intermediate operation expression, an operation of any one operation expression is performed by using an operation value of another operation expression, and accordingly, the number of operations of a processor for generating lookup tables can be greatly reduced.

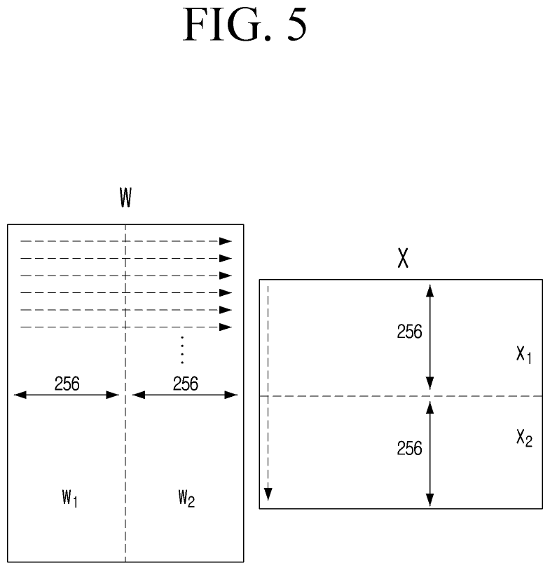

FIG. 5 illustrates an operation method of a neural network model according to an embodiment.

Referring to FIG. 5, the processor 120 may generate lookup tables, and perform operations of the neural network model based on the lookup tables. The processor 120 may generate a plurality of lookup tables for all input values of input data, perform operations of the neural network model based on the plurality of lookup tables, generate some lookup tables for some input values of input data, perform some operations of the neural network model based on some lookup tables, generate some lookup tables for the remaining input values of input data, and perform the remaining operations of the neural network model based on some lookup tables.

Specifically, the processor 120 may divide the input matrix into a first input matrix and a second input matrix based on predetermined rows, and divide the weight matrix into a third weight matrix and a fourth weight matrix based on predetermined columns. The predetermined rows may be n/2 rows if the number of rows of the input matrix is n, and the predetermined columns may be n/2 columns if the number of columns of the weight matrix is n. However, the examples are non-limiting.

The processor 120 may generate a plurality of lookup tables based on the input values of each column of the first input matrix, obtain operation data corresponding to each row of the third weight matrix from the plurality of lookup tables, generate a plurality of lookup tables based on the input values of each column of the second input matrix, and obtain operation data corresponding to each row of the fourth weight matrix from the plurality of lookup tables. The aforementioned technical idea can be applied to the method of generating lookup tables and obtaining operation data based on the lookup tables, and thus detailed explanation will be omitted.

When the number of rows of the input matrix and the number of columns of the weight matrix are 512, respectively, the processor 120 may divide the input matrix into an input matrix X1 and an input matrix X2 based on 256 rows, and divide the weight matrix into a weight matrix W1 and a weight matrix W2 based on 256 columns. The processor 120 may generate lookup tables based on the input values of the input matrix X1, obtain operation values corresponding to the weight matrix W1 from the lookup tables, generate lookup tables based on the input values of the input matrix X2, and obtain operation values corresponding to the weight matrix W2 from the lookup tables.

As described above, a plurality of operation values are obtained incrementally through divided matrices, and accordingly, the problem of memory overload may be avoided and the memory may be effectively used.

When the processor 120 is implemented as a plurality of processors, operation values corresponding to the weight matrix W1 may be obtained from the lookup tables based on the input matrix X1 and operation values corresponding to the weight matrix W2 may be obtained from the lookup tables based on the input matrix X2 in parallel through the plurality of processors. Accordingly, the time spent for the operations can be reduced.

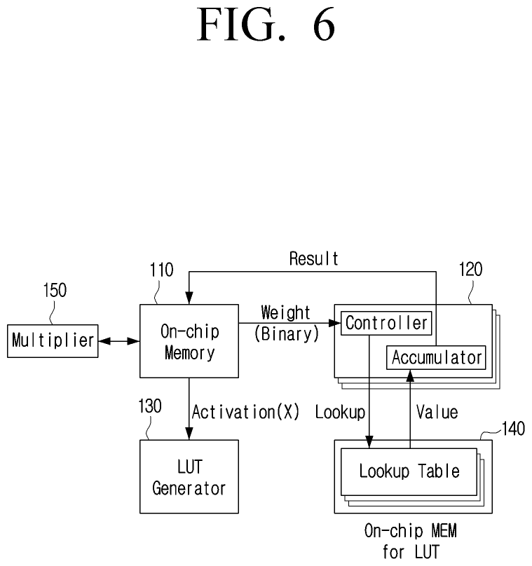

FIG. 6 illustrates an electronic apparatus according to an embodiment.

Referring to FIG. 6, the electronic apparatus includes a first memory 110, a processor 120, a lookup table (LUT) generator 130, a second memory 140, and a multiplier 150.

The first memory 110 may store an input matrix, a scaling factor for operations of a neural network model, and a weight matrix. The input matrix may include a plurality of input values, and the weight matrix may include weight values quantized to 0 or 1 as described above.

The LUT generator 130 may load the input matrix from the first memory 110. The LUT generator 130 may obtain operation values for the input values of the input matrix for each of the binary data. Specifically, when generating lookup tables of binary data of n bits, the LUT generator 130 may obtain n input values from each column of the input matrix, and obtain operation values for each of the binary data based on the binary data and then input values. The LUT generator 130 may match information of the columns and the rows of the input matrix, which became a basis for generation of lookup tables, to the lookup tables, and then store the matched information. The information of the columns may be used in determining lookup tables corresponding to each column of the output matrix among the plurality of lookup tables generated for each column of the input matrix. The information of the rows may be used in determining lookup tables including operation values corresponding to each column of the weight matrix among the plurality of lookup tables corresponding to each column of the output matrix.

The LUT generator 130 may generate lookup tables based on binary data of 8 bits. Specifically, the LUT generator 130 may obtain eight input values in each column of the input matrix, and obtain operation data for each of the binary data based on the binary data of 8 bits and the eight input values. This operation is performed in consideration of the processor 120, e.g., a CPU, processing data in byte units, and accordingly, may prevent overload of the processor by not performing shift operations for processing data of at a bit level.

The second memory 140 may store at least one lookup table. The second memory 140 may be a scratch pad memory (SPM) that temporarily stores data such as a lookup table.

The processor 120 may load the weight matrix from the first memory 110, and load lookup tables from the second memory 140. The processor 120 may obtain operation values of the weight values of the weight matrix from the lookup tables, accumulate the operation values in the accumulator, and obtain output values of the output matrix (i.e., the weight matrix B*the input matrix X) based on the summation of the operation values accumulated in the accumulator. The processor 120 may store information on the output values of the output matrix in the first memory 110. Afterwards, the multiplier 150 may load the output values stored in the first memory 110 and the scaling factor, and perform a multiplication operation of the output values and the scaling factor.

Although FIG. 6 illustrates the first memory 110 and the second memory 120 as separate components, the first memory 110 and the second memory 120 may be embodied as one memory, and/or may also be included inside the processor 120. The LUT generator 130 may also be included in the processor 120. In addition, the multiplier 150 may also be included in the processor 120.

In the above-described embodiments, lookup tables are generated based on input values of input data. However, an electronic apparatus according to an embodiment may generate lookup tables based on weight values of weight data by applying the aforementioned method in a reverse way. That is, the processor 120 may leave weight values as they are (i.e., processing them as real number values), and quantize input values of the input data. Thereafter, the processor 120 may generate lookup tables wherein operation values are matched with each of the binary data based on the weight values and the binary data of n bits, and obtain operation data corresponding to the input data from the lookup tables. Such lookup tables based on weight data may be used in operations of a language model wherein the size of input data is small and the size of weight data is big. The lookup tables based on input data described above may be used in operations of an image model wherein the size of input data is big and the size of weight data is small.

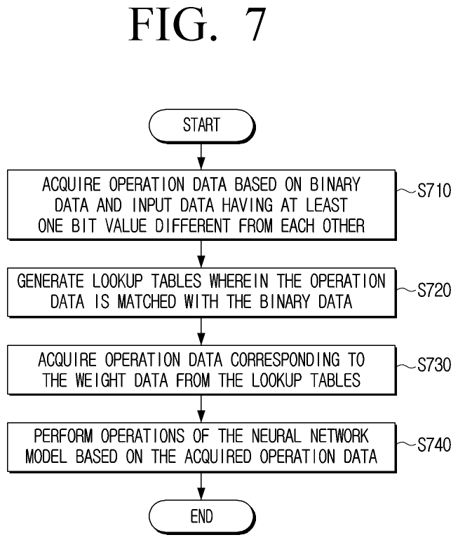

FIG. 7 is a flow chart illustrating a control method of an electronic apparatus according to an embodiment.

Referring to FIG. 7, in step S710, the electronic apparatus acquires operation data based on binary data and input data having at least one bit value different from each other. The binary data may include a bit value 0 or a bit value 1, the input data may include a plurality of input values, and the operation data may include a plurality of operation values. Each of the input data and the operation data may be expressed as a matrix. Specifically, the electronic apparatus may obtain n input values in each column of the input matrix, and obtain operation data for each of the binary data based on the binary data and the n input values.

In step S720, the electronic apparatus generates lookup tables in which the operation data is matched with the binary data.

In step S730, the electronic apparatus acquires operation data corresponding to the weight data from the lookup tables. The weight data may include the plurality of weight values of the matrix. The electronic apparatus may identify n weight values corresponding to the n input values in each row of the weight matrix, and identify binary data corresponding to the identified n weight values among the binary data. The electronic apparatus may obtain operation data corresponding to the identified binary data from the lookup tables.

In step S740, the electronic apparatus performs operations of the neural network model based on the obtained operation data.

Methods according to the aforementioned various embodiments of the disclosure may be implemented in the form of software or an application that can be installed on conventional display apparatuses.

A non-transitory computer readable medium storing a program sequentially performing the controlling method of an electronic apparatus according to the disclosure may also be provided.

A non-transitory computer readable medium refers to a medium that stores data semi-permanently, and is readable by machines, but not a medium that stores data for a short moment such as a register, a cache, and a memory. Specifically, the aforementioned various applications or programs may be provided while being stored in a non-transitory computer readable medium such as a compact disc (CD), a digital versatile disc (DVD), a hard disc, a blue-ray disc, a universal serial bus (USB), a memory card, a ROM, etc.

While the disclosure has been particularly shown and described with reference to certain embodiments thereof, it will be understood by those of ordinary skill in the art that various changes in form and details may be made therein without departing from the spirit and scope of the disclosure as defined by the following claims and their equivalents.

What is claimed is:

1. An electronic apparatus that performs an operation of a neural network model, the electronic apparatus comprising:
a memory configured to store weight data including quantized weight values of the neural network model; and
a processor configured to:
obtain operation data based on input data and binary data having at least one bit value different from each other,
generate a lookup table by matching the operation data with the binary data,
identify operation data corresponding to the weight data from the lookup table, and
perform an operation of the neural network model based on the identified operation data.

2. The electronic apparatus of claim 1, wherein the binary data includes n bit values,
wherein the input data includes a plurality of input values of a matrix, and
wherein the processor is further configured to:
obtain n input values in each column of the matrix, and
identify the operation data for each of the binary data based on the binary data and the n input values.

3. The electronic apparatus of claim 2, wherein the weight data includes a plurality of weight values of the matrix, and
wherein the processor is further configured to:
identify n weight values corresponding to the n input values in each row of the matrix,
identify binary data corresponding to the identified n weight values among the binary data, and
identify operation data corresponding to the identified binary data from the lookup table.

4. The electronic apparatus of claim 3, wherein the processor is further configured to:
determine, among a plurality of lookup tables generated based on input values of each column of the matrix, a lookup table corresponding to each column of an output matrix for the input data, and
derive output values for each column of the output matrix from each of the lookup tables.

5. The electronic apparatus of claim 3, wherein the processor is further configured to:
divide the matrix including the plurality of input values into a first matrix and a second matrix based on predetermined rows,
divide the matrix including the plurality of weight values into a third matrix and a fourth matrix based on predetermined columns,
generate a first plurality of lookup tables based on input values of each column of the first matrix,
identify first operation data corresponding to each row of the third matrix from the first plurality of lookup tables,
generate a second plurality of lookup tables based on input values of each column of the second matrix, and
identify second operation data corresponding to each row of the fourth matrix from the second plurality of lookup tables.

6. The electronic apparatus of claim 2, wherein the processor is further configured to:
obtain eight input values from each column of the matrix, and
identify the operation data for each of the binary data based on the binary data and the eight input values.

7. The electronic apparatus of claim 2, wherein the processor is further configured to:
based on a first operation expression and a second operation expression having a same intermediate operation expression existing in a plurality of operation expressions based on the binary data and the n input values, perform the operation of the second operation expression based on the operation value of the first operation expression.

8. A method for controlling an electronic apparatus to perform an operation of a neural network model, the method comprising:
obtaining operation data based on input data and binary data including at least one bit value different from each other;
generating a lookup table by matching the operation data with the binary data;
identify operation data corresponding to weight data including quantized weight values of the neural network model from the lookup table; and
performing an operation of the neural network model based on the identified operation data.

9. The method of claim 8, wherein each of the binary data includes n bit values,
wherein the input data includes a plurality of input values of a matrix, and
wherein the obtaining operation data comprises:
obtaining n input values in each column of the matrix; and
identifying the operation data for each of the binary data based on the binary data and the n input values.

10. The method of claim 9, wherein the weight data includes a plurality of weight values of a matrix, and
wherein performing the operation of the neural network model comprises:
identifying n weight values corresponding to the n input values in each row of the matrix,
identifying binary data corresponding to the identified n weight values among the binary data,
identifying the operation data corresponding to the identified binary data from the lookup table, and
performing the operation of the neural network model based on the identified operation data.

11. The method of claim 10, wherein performing the operation of the neural network model comprises:
determining, among a plurality of lookup tables generated based on input values of each column of the matrix, a lookup table corresponding to each column of an output matrix for the input data, and
identifying output values of each column of the output matrix from each of the lookup tables.

12. The method of claim 10, wherein identifying the operation data comprises:
dividing the matrix including the plurality of input values into a first matrix and a second matrix based on predetermined rows;
dividing the matrix including the plurality of weight values into a third matrix and a fourth matrix based on predetermined columns;
generating a first plurality of lookup tables based on input values of each column of the first matrix;
identifying first operation data corresponding to each row of the third matrix from the first plurality of lookup tables;
generating a second plurality of lookup tables based on input values of each column of the second matrix; and
identifying second operation data corresponding to each row of the fourth matrix from the second plurality of lookup tables.

13. The method of claim 9, wherein identifying the operation data comprises:
obtaining eight input values from each column of the matrix; and
identifying the operation data for each of the binary data based on the binary data and the eight input values.

14. The method of claim 9, wherein generating the lookup table comprises:
based on a first operation expression and a second operation expression having a same intermediate operation expression existing in a plurality of operation expressions based on the binary data and the n input values, performing the operation of the second operation expression based on the operation value of the first operation expression.
